(19) United States
(12) Patent Application Publication
(10) Pub. No.: US 2009/0044854 A1
(43) Pub. Date: Feb. 19, 2009

(54) Framed Solar Module and Method of Installing

(75) Inventors: Neil V. Placer, Frederick, MD (US); Paul L. Garvison, Frederick, MD (US)

Correspondence Address: CAROL WILSON;BP AMERICA INC., MAIL CODE 5 EAST, 4101 WINFIELD ROAD, WARRENVILLE, IL, 60555, US

(73) Assignee: BP Corporation North America Inc., Warrenville, IL (US)

(21) Appl. No.: 12/185,165

(22) Filed: Aug. 4, 2008

Related U.S. Application Data
(60) Provisional application No. 60/973,785, filed on Sep. 20, 2007.
(60) Provisional application No. 60/955,410, filed on Aug. 13, 2007.

(51) Int. Cl. E04D 13/18; H02N 6/00; E04B 1/00

(52) U.S. Cl. 136/251; 52/745.21; 52/173.3

(57) ABSTRACT

A framed solar module and a method for installing. The frame comprises contoured sides that can conform with the tiers of tiles on an inclined roof. The framed solar module can be installed with brackets which do not require roof-penetrating fasteners. Each front bracket has a clip portion and a face portion. The front brackets are manipulated between two adjacent overlapping tiers of tiles until the clip portion of each bracket engages the rear of a tile. A first module is then attached to the front bracket, e.g. the module is positioned so that the faces of the front brackets will lie inside the front edge of the frame. A fastener, such as a bolt or other threaded faster, is passed through an opening in the front of the frame and is threaded into an opening in the face of the front bracket to secure the module to the bracket. Additional modules to form an array are installed in the same manner by using additional, properly spaced sets of front brackets. A back bracket(s) is attached to the back of the uppermost module to aid in securing the array to the roof.

This application claims the benefit of priority from U.S. Provisional Patent Application No. 60/955,410, filed Aug. 13, 2007, and U.S. Provisional Patent Application No. 60/973,785, filed Sep. 20, 2007, the entirety of which is expressly incorporated herein by reference.

### FIELD OF THE INVENTION

The present invention relates to mounting a solar module on a support surface and in one of its aspects relates to a system and an installation method installing solar modules onto an existing roof of a building without compromising or modifying the waterproof and/or fire resistance of the roof.

### BACKGROUND OF THE INVENTION

In recent years, considerable advances have been made in using photovoltaic cells or the like to directly convert solar energy into useful electrical energy. Typically, a plurality of photovoltaic cells are encased between a transparent cover sheet (e.g. glass, plastic, etc.) and a backsheet, to form flat, rectangular-shaped modules (sometimes also called “laminates”) of a manageable size (e.g. 2½′×5′). While some modules may be “unframed”, most manufacturers now provide frames around the peripheries of the modules to thereby increase the stability of the modules and to aid in the installation of the modules.

While several different installation techniques have been proposed, typically, a framed module is secured on a roof by fasteners (e.g. lag bolts, screws, etc.) which have to penetrate and pass through the existing roofing material. This can compromise the waterproof and/or fire resistance qualities of the roof and result in, for example, leaks.

Further, the positioning of a solar module or an array of several modules is effectively limited to spots on the roof which are adequately supported by a framing member (e.g. a rafter) or roofing material strong enough to properly receive and retain the lag screws over the operational life of the array. This can create problems where the roof is singled over slats or where the decking material is comprised of thin plywood, chipboard, or the like. Also, this may require an array to be positioned in a less desirable aesthetical or operational area on a particular roof.

Still further, the installation of arrays of framed modules can be relatively tedious and time consuming. That is, the task of (a) aligning two, relatively bulky and weighty modules, aligning the respective openings in adjacent frames, and (b) holding them in position while threading a lag screw or the like through the aligned openings and into and through the roof can be a difficult task for a single installer.

All of the above problems are magnified when an array of modules is to be installed onto a particular roof which is comprised of relatively thick or contoured units, (e.g. curved tiles, slabs of slate, etc.; hereinafter collectively called “tiles”). In addition to the time involved, the drilling of holes through slate or concrete or ceramic tiles for lag screws or the like presents the real problem of cracking or otherwise damaging that tile(s). As will be recognized, this can lead to substantial delays and increased costs due to need to replace the affected tiles before the installation can be completed.

Also, “tiled” roofs present an additional problem in that, the “flat” frame of a typical module will not lie flat on the tiles since it normally spans more than one row of the relative thick tiles. Accordingly this presents a real problem in securing the frame; hence the module, to the roof. Attempts to do so, if it can be done at all, can be labor intensive and the result may not be sufficiently aesthetically appealing to all viewers.

Since the total cost of any solar array includes its installation costs, any savings in time and man power needed in mounting the array, especially on existing tiled roofs, become important considerations in the use of solar energy over more conventional sources. Further, if the exact placement of an array is not limited to certain locations on the roof, the final appearance of the array can be made more esthetically pleasing which can also aid in the marketing of renewable, solar power to the public.

### SUMMARY OF THE INVENTION

The present invention provides a framed, solar module of photovoltaic (PV) cells and a method for installing a solar array of framed modules on a support surface such as a roof of a building without requiring the use of any roof penetrating fasteners which might compromise the waterproof and fire resistance integrity of the roof.

More specifically, in one embodiment of the module of the present invention is comprised of one or more PV cells which are encased in a frame whose sides are contoured to basically conform with the contour of an inclined roof which has been surfaced with tiers roofing material, preferably a relatively thick roofing material such as, for example, concrete or ceramic, curved tiles. This allows the modules to lie substantially flat on the roof which simplifies installation and gives a pleasing appearance when the installation of the solar array is completed.

The array is installed with one or more front brackets, each having a clip portion and a face portion. Each front bracket is first manipulated between two adjacent overlapping tiers of tiles which will lie at the lower edge of the first or uppermost module in the array when the module is installed. The front bracket is pushed rearward between the tiles until the clip portion drops in behind the rear edge of the lowermost of the two tiers. The bracket is then positioned horizontally and pulled forward to pull the clip portion into engagement with the rear of the tile to thereby secure the bracket in place with the face of each front bracket extending upwardly.

Next, the first (i.e. uppermost) module in a row of the array is positioned on the tiles above the front brackets and is lowered onto the tiles whereby the front of the module can be attached to the front brackets. One means for attaching the module to the brackets involves lowering the module over the bracket so that the faces of the front brackets will lie just inside the front edge of the frame of the uppermost module. A threaded fastener (e.g. a bolt or the like) is passed through an opening the front of the frame and is threaded into an opening in the face of the front bracket. By tightening the bolt, the frame will be drawn towards the secured bracket thereby securing the module to the bracket and at the same time, forcing the contoured sides of the frame into good contact with the edge between the overlapping tiles.

If not installed at the same time as the first set of front brackets is installed, a second set of front brackets is then installed between two overlapping tiers of tiles which lie below the first module and which will lie adjacent the lower edge of a second module. The above-described procedure is repeated until all of the modules in the first row of the array are installed. If the array is to consist of more than one row of inclined modules, the second, third, etc. rows of modules will be installed as described above.

The uppermost module in each row of an array has at least one back bracket attached to the back of the frame. The back bracket is comprised of a clip portion similar to that of the front brackets and a surface to attach the back bracket to the underside of the rear of the frame. Preferably, the back brackets are attached to and are manipulated into position as the uppermost module is positioned onto the roof. As before, the brackets are moved inward until the clip portion drops below the edge of the tile in the uppermost tier and then pulled forward as the module is positioned so that the clip portion will engage the rear of the tile to there further secure the uppermost module against downward movement on the inclined roof.

### BRIEF DESCRIPTION OF THE DRAWINGS

The actual construction operation, and apparent advantages of the present invention will be better understood by referring to the drawings, not necessarily to scale, in which like numerals identify like parts and in which:

FIG. 1 is a perspective view of an array of solar modules installed onto a support surface (e.g. roof) in accordance with an embodiment the present invention;

FIG. 2 is a simplified, partial cross-sectional view of the modules and roof of FIG. 1;

FIG. 2A is an enlarge segment taken within lines 2A-2A of FIG. 2;

FIG. 3 is an exploded view of the components of embodiments of the present invention along with two typical tiles of the roof of FIG. 1.

While the invention will be described in connection with its preferred embodiments, it will be understood that this invention is not limited thereto. On the contrary, the invention is intended to cover all alternatives, modifications, and equivalents that may be included within the spirit and scope of the invention, as defined by the appended claims.

### DETAILED DESCRIPTION OF THE INVENTION

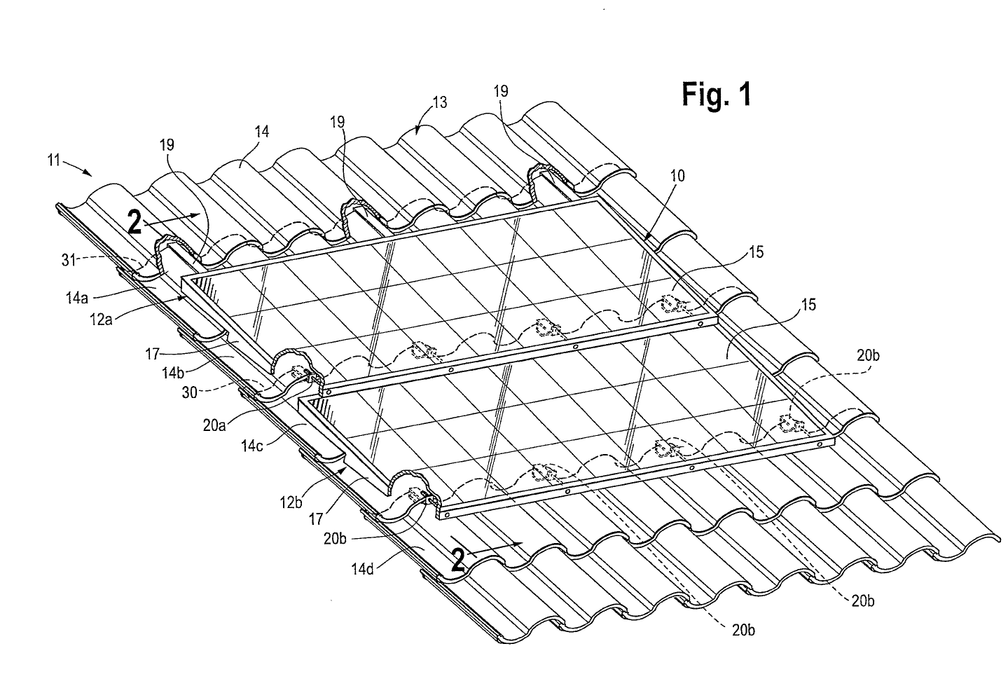

Referring now to the drawings, FIG. 1 illustrates a solar array 10 which has been mounted on a support surface (e.g. roof 11 of a house or the like) in accordance with the present invention. While the present invention may be used on any roofs which lends themselves to the present installation procedure, as illustrated, roof 11 is one which has been roofed with overlapping tiers or rows of a relatively thick roofing material; i.e. well known, commonly-available, curved tiles 14 such as concrete, ceramic, or similar tiles. This type of roof is well known and is in widespread use in many parts of the United States of America and other countries.

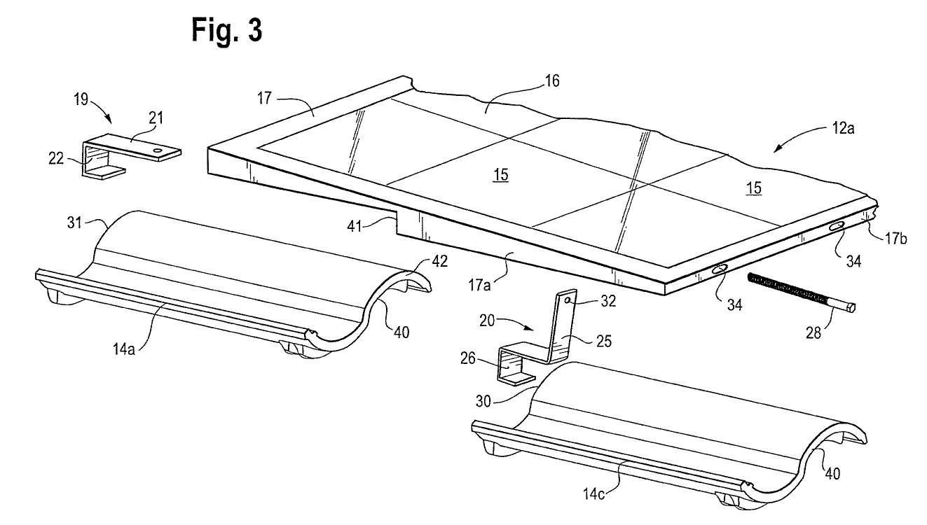

Array 10 is comprised of a plurality (only two shown) of solar modules 12a, 12b, which have been positioned on and secured to the roofing material 13 without the need for fasteners (e.g. lag screws) penetrating the roofing material thereby maintaining the waterproof and fire resistance qualities of the roof. As will be fully understood in the art, a typical solar module 12 is formed by positioning a plurality of photovoltaic (PV) cells 15 (only a few numbered in FIGS. 1 and 3) between a sheet of a transparent material 16 (e.g. glass, plastic, etc.) (FIG. 3) and a backing sheet (not shown), whereby the assembled PV cells form a flat, typically rectangular arrangement, as shown in the figures.

To complete the module 12, the assembled PV cells 15 are encased within a frame 17 which can be of metal, molded plastic, or other suitable material. Frame 17 has a front or lower edge, a back or upper edge, and two sides. As shown, the sides of the frame are formed with a contoured profile (17a in FIG. 3) which has a “stepped” portion 41. This allows the frame to substantially follow the contour of, for example, the stepped tiers of tiles 14 when installed thereby providing a good fit between the frame of the module and the surface of the roof. Also, conformity between the frame 17 and roof 11 allows the surface of module 12 to lie substantially parallel to the overlapping tiles 14 which makes installation easier and gives a more pleasing appearance for the finished array 10 when the installation is complete. While a “stepped” frame 17 having a particular profile for use on a particular roof 11 is shown, it should be recognized that the frame can be molded or otherwise formed with different configurations to match the profile of the particular layered roof on which it is to be installed.

After the modules 12 are assembled within their frames 17, the modules are then installed onto roof 11. The present invention allows the modules to be installed at almost any position on the roof since no screws, nails, bolts, or the like are used to affix the modules on the roof. Accordingly, the positioning of the modules are not restricted to areas overlying support members such as rafters, as is typically the case with prior installation techniques.

In accordance with the present invention, the modules 12 are secured to a tiled roof 11 with front brackets 20, as will be explained in detail below. Basically, the front brackets 20 are adapted to engage the rear edge of tiles in a particular tier and to the module to thereby secure the module in place and to keep it from moving downward on the roof. Where the module is to be the uppermost module in an array, a second set of brackets 19 are attached to the rear of the module and are adapted to engage the rear edge of a higher tier of tiles as will be more fully explained below.

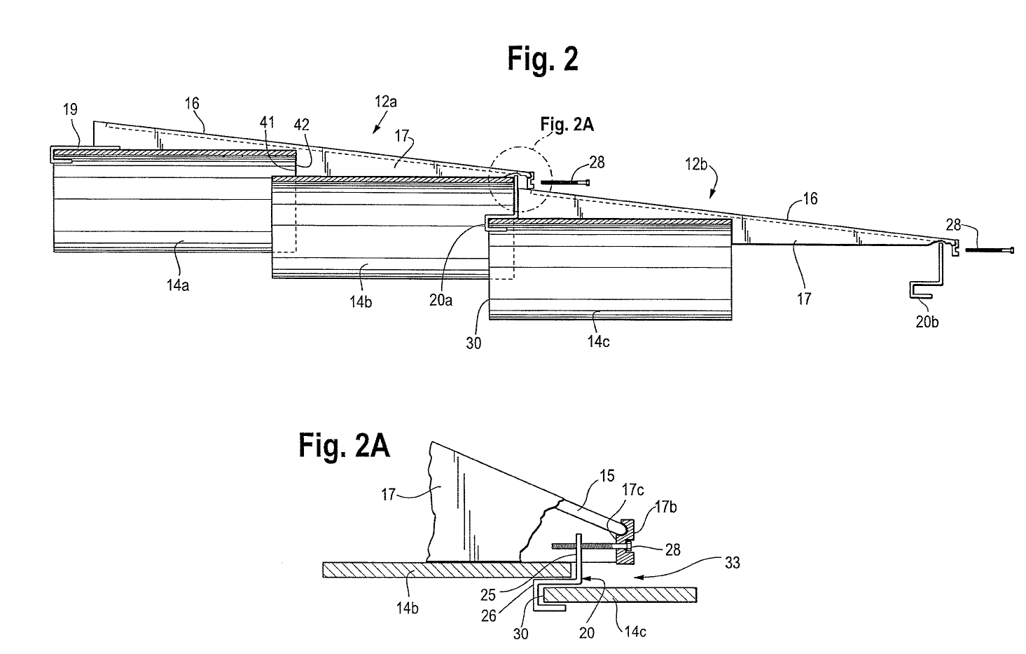

While each bracket 20 may have a slightly different configuration depending on a particular roof, each bracket preferably has a (a) face portion 25 which is adapted to be attached to the inner side of the front edge 17b (FIG. 2A) of frame 17 and (b) a clip portion 26 which is adapted to engage the rear edge of a tile 14c, as will be explained below. Again, the number of front brackets 20 used may vary depending on the dimensions of module 12 and other factors involved in a particular installation (four shown in dotted lines in FIG. 1).

An installer manipulates the clip portion 26 of each front bracket 20 between the overlap of two adjacent tiers of tiles through, for example in the case of a curved tile, the respective, curved portions (i.e. channels 40, only numbered in FIG. 3) of the appropriate tiles 14b until the clip portion 26 of the bracket 20 clears the rear edge 30 of a respective tile 14c and the clip drops down behind rear edge 30. The bracket 20 is then manually positioned along the edge of the tile and pulled forward to bring the clip in under edge 30 of tile 14c thereby securing bracket 20 in position and locking it against any further downward motion. This manipulative step is repeated with each of the horizontally spaced brackets, until all of the brackets are clipped onto the rear edges of tiles 14c.

Next, the first or uppermost module 12a to be installed in the array 10 is positioned at the uppermost point of the array and the front of frame 17 is attached to each of the front brackets 20. While various means can be used to attach the frame to the brackets, preferably as illustrated, the front of frame 17 is lowered over the faces 25 of front brackets as best seen in FIG. 2A and the “step” 41 (FIGS. 2 and 3) is brought into firm engagement with the front edge 42 of tile 14a. A respective fastener (e.g. threaded bolt 28 or the like) is then passed through opening 34 in front edge 17b of frame 17 and into the preferably threaded opening 32 in face 25 of bracket 20 (FIG. 3). As bolt 28 is threaded into the bracket 20, the head of the bolt will bear against edge 17b of frame 17 which pulls the otherwise loose bracket forward until the clip portion 26 of the bracket 20 firmly engages the rear edge 30 of tile 14c thereby locking module in place. This procedure is repeated for each of the horizontally spaced front brackets 20 to secure module 12a in place and prevents any downward movement on the tiles.

A second set of front brackets 20b are then manipulated into place behind a lower tier of tiles 14d (FIG. 1) in the same manner as described above. The rear edge of a second module 12b is moved into the gap 33 (FIG. 2a) which exists under the front edge of module 12a and the front brackets 20b are attached to the front edge of module 12b in the same manner as described above to thereby secure module 12b in place. This procedure is repeated until all of the modules in the first inclined row of the array are installed.

As mentioned above, one or more back brackets 19 are also attached to the rear of a module on those modules which are to form the uppermost modules (i.e. 12a) in each, individual row of an array (only one row with two modules shown). Back bracket 19 is preferably comprise (a) a surface 21 which is adapted to be secured to the underside of the rear of module 12a and (b) a clip portion 22 which is adapted to engage the rear edge 31 of tile 14a, much in the same way as described above. In installing a first module 12a, back bracket(s) 19 is preferably secured to the rear of module 12a and is manipulated into place behind edge 31 of tile 14a as the module is being positioned. Once the clip portion 22 of bracket 19 is in place, the frame 17 of module 12a is lowered onto the tiles and the pre-positioned front brackets 20 are secured thereto to complete the installation of that module.

The above described process is repeated until all of the modules have been installed. Since no fasteners are needed which penetrate the tiles, the waterproof and fire integrity of the roof remains unaffected, regardless of the size or position of the array. Also, since no drilling or like is required, the real possibly of damage to the tiles is eliminated. Still further, the finished array presents a pleasing appearance when the installation is complete.

What is claimed is:

1. A solar module adapted to be mounted on a roof which has overlapping tiers of roofing material, said module comprising:
one or more photovoltaic cells (PV);
a frame affixed around said PV cells, said frame having a contoured profile whereby said frame is adapted to lie parallel or substantially parallel to selected overlapping tiers of said roofing material when in an operable position;
at least one front bracket adapted to be positioned behind one of said overlapping tiers of said roofing material; and
connecting means for connecting said front bracket to said frame to thereby secure said module to said roof.

2. The solar module of claim 1 wherein said frame has a front edge, a back edge, and two sides, and wherein said contoured profile of said frame has a stepped portion along said sides of said frame whereby said stepped portion engages the front edge of one of said overlapping tiers when said module is in an operable position on said roof.

3. The solar module of claim 2 where said front bracket comprises:
a clip portion adapted to engage the rear edge of one of said overlapping tiers of said roofing material when in an operable position; and
a face portion adapted to be connected to the front edge of said frame by said connecting means.

4. The solar module of claim 3 including:
a back bracket adapted to engage the rear edge of another of said overlapping tiers of said roofing material, said back bracket adapted to be connected to said back edge of said frame.

5. The solar module of claim 4 wherein said back bracket comprises:
a clip portion adapted to engage said rear edge of said another tier; and
a surface adapted to be connected to the underside of said back edge of said frame.

6. The module of claim 3 wherein:
said face portion of said front bracket having a threaded opening therethrough, said face portion adapted to lie behind said front edge of said frame when said module is in an operable position on said roof;
and wherein said connecting means comprises a threaded fastener passing through an opening in said front edge of said frame and threaded into said threaded opening in said face of said front bracket.

7. Installation means for installing a solar module to a roof wherein said roof has overlapping tiers of a roofing material thereon, said installing means comprising:
a front bracket comprising
a clip portion adapted to engage the rear edge of one of said overlapping tiers of said roofing material when said front bracket is in an operable position;
a face portion adapted to be connected to the front edge of said module.

8. The installation means of claim 7 further comprising:
a means for connecting said face portion of said bracket to said front edge of said module.

9. The installation means of claim 8 further comprising:
a back bracket comprising a clip portion adapted to engage said rear edge of a upper tier; and
a surface adapted to be connected to the underside of the back edge of said frame.

10. A solar array adapted to be installed on an inclined roof having overlapping tiers of tiles, said solar array comprising:
a first module comprised of photovoltaic (PV) cells enclosed within a frame, said frame having a front edge, a back edge, and two sides, said sides having a stepped profile for conforming with overlapping tiers of said tiles, said first module being positioned on said inclined roof at the uppermost point of said array;
at least one first front bracket attached to a first tier of tiles;
a first means for connecting said at least one first front bracket to said front edge of said frame of said first module;
a second module comprised of PV cells enclosed within a frame, said frame having a front edge, a back edge, and two sides, said sides having a stepped profile for conforming with overlapping tiers of said tiles, said second module being positioned below and adjacent said first module on said inclined roof;
at least one second front bracket attached to a second tier of tiles; and
a second means for connecting said at least one second front bracket to said front edge of said frame of said second module.

11. The array of claim 10 further comprising:
at least one back bracket on the back of said frame and attached to the uppermost tier of tiles on which said array is installed.

12. The array of claim 10 wherein at least one first front bracket and said second front bracket comprises:
a clip portion adapted to engage the rear edge of a tile in said first tier of tiles wherein said front bracket is in an operable position; and
a face portion adapted to be connected to the front edge of said module.

13. The array of claim 12 wherein said at least one first front bracket comprises:
a plurality of front brackets horizontally-spaced across said first tier of tiles;
and wherein said at least one second front bracket comprises
a plurality of front brackets horizontally-spaced across said second tier of tiles.

14. The array of claim 12 wherein:
said face portion of each of said front brackets having a threaded opening therethrough, said face portion adapted to lie behind said front edge of said frame when said module is in an operable position on said roof;
and wherein said connecting means comprises
a threaded fastener passing through an opening in said front edge of said frame and threaded into said threaded opening in said face of said front bracket to thereby secure said module to said roof.

15. A method for installing a solar array on an inclined roof of overlapping tiers of tiles, said method comprising:
first attaching a first set of front brackets to selected tiles which are spaced in one tier of tiles without the use of tile-penetrating fasteners;
positioning a first uppermost solar module of photovoltaic PV) cells on said roof so that its lower edge is adjacent with each of said set of front brackets;
connecting each of said brackets to said first module to said lower edge of said module to secure said first module to said roof.

16. The method of claim 15 further comprising:
attaching a second set of front brackets to tiles spaced in a tier which is below said one of said tier without the use of tile-penetrating fasteners;
positioning a second solar module of photovoltaic (PV) cells below and adjacent said first module and in loose contact with each of said second set of front brackets;
connecting each of said second brackets to said second module to secure said second module on said roof.

17. The method of claim 16 further comprising:
at least one back bracket attached to the rear of said first module and connected to an adjacent tier of tiles.

18. A method for installing a solar array on an inclined roof of overlapping tiers of tiles, said method comprising:
manipulating a first set of front brackets between overlapping tiers until each of said brackets engages the rear edge of a respective tile in the lower of the overlapping tiers to thereby secure said brackets in place without the use of tile-penetrating fasteners;
positioning an uppermost solar module of photovoltaic (PV) cells on said roof and in loose contact with each of said set of front brackets;
connecting each of said brackets to said first module to secure said first module on said roof.

19. The method of claim 18 further comprising:
attaching at least one back bracket to said uppermost module; and
manipulating said at least one back bracket between higher tiers of overlapping tiles until said bracket engages the rear edge of a respective tile in the lower tier of said overlapping higher tiers.

20. The method of claim 18 further comprising:
manipulating a second set of front brackets between lower overlapping tiers until each of said brackets engages the rear edge of a respective tile in the lower of the overlapping tiers to thereby secure said second front brackets in place without the use of tile-penetrating fasteners;
positioning a second solar module on said roof below and adjacent to said uppermost module and in loose contact with each of said second set of front brackets;
connecting each of said second set of brackets to said second module to secure said second module on said roof.

21. A solar module adapted to be mounted on a roof which has overlapping tiers of roofing material, said module comprising:
one or more photovoltaic cells (PV);
a frame affixed around said PV cells, said frame having a contoured profile whereby said frame is adapted to lie on top of selected overlapping tiers of said roofing material when in an operable position.

22. The solar module of claim 1 wherein the solar module is adapted to be mounted on a roof which has overlapping tiers of a relatively thick roofing materials.

23. The solar module of claim 22 wherein the relatively thick roofing material is one or more of a curved concrete or ceramic roofing tile.

24. The solar module of claim 1 wherein said at least one front bracket is adapted to be positioned behind one of said overlapping tiers of said roofing material without the use of fasteners that are positioned in or through the roofing material.

25. The solar array of claim 10 wherein said at least one first front bracket is attached to said first tier of tiles without the use of any tile-penetrating fasteners.

26. The solar array of claim 10 wherein said at least one second front bracket is attached to said second tier of tiles without the use of any tile-penetrating fasteners.

27. The solar array of claim 10 adapted to be installed on an inclined roof having overlapping tiers of curved tiles.

28. The method of claim 15 for installing a solar array on an inclined roof of overlapping tiers of curved tiles.

29. The method of claim 28 wherein the curved tiles are concrete, ceramic or a combination thereof.

30. The method of claim 18 for installing a solar array on an inclined roof of overlapping tiers of curved tiles.

31. The method of claim 30 wherein the curved tiles are concrete, ceramic or a combination thereof.

32. The solar module of claim 21 wherein the frame comprises metal, plastic or a combination thereof.

33. The solar module of claim 32 wherein the frame comprises plastic.

34. The solar module of claim 32 wherein the frame comprises metal.

35. The solar module of claim 33 wherein the frame comprises injection molded plastic.

36. The solar module of claim 34 wherein the frame comprises aluminum.

37. A frame for a solar module, the frame comprising a contoured profile along the bottom of said frame whereby said frame is adapted to lie on top of selected overlapping tiers of roofing material when in an operable position.

38. The frame of claim 37 wherein the shape of the contoured profile corresponds to the shape of the overlapping tiers of said roofing material.

39. The frame of claim 37 wherein the frame comprises metal, plastic or a combination thereof.

40. The frame of claim 37 wherein the frame comprises plastic.

41. The frame of claim 37 wherein the frame comprises metal.

42. The frame of claim 37 wherein the frame comprises injection molded plastic.

43. The frame of claim 37 wherein the frame comprises aluminum.

44. The frame of claim 38 wherein the shape of the contoured profile is stepped-shaped.
